(19) United States
(12) Patent Application Publication
(10) Pub. No.: US 2022/0253434 A1
(43) Pub. Date: Aug. 11, 2022

(54) APPLICATION PROGRAMMING INTERFACE SERVICE SEARCH SYSTEM AND SEARCH METHOD THEREOF

(71) Applicants: DATA SYSTEMS CONSULTING CO., LTD., New Taipei City (TW); Digiwin Software Co., Ltd, Shanghai (CN)

(72) Inventors: Kuan-Hui Wu, Shanghai (CN); GUOXIN SUN, Shanghai (CN)

(73) Assignees: DATA SYSTEMS CONSULTING CO., LTD., New Taipei City (TW); Digiwin Software Co., Ltd, Shanghai (CN)

(21) Appl. No.: 17/335,101

(22) Filed: Jun. 1, 2021

(30) Foreign Application Priority Data
Feb. 9, 2021 (CN) 202110179280.7

(51) Int. Cl. G06F 16/242; G06F 9/54; G06F 16/22; G06F 40/30; G06F 40/279; G06F 40/247; G06F 40/58; G06F 40/53

(52) U.S. Cl. CPC G06F 16/243; G06F 9/547; G06F 16/2228; G06F 40/53; G06F 40/279; G06F 40/247; G06F 40/58; G06F 40/30

(57) ABSTRACT

An application programming interface (API) service search system and an API service search method are provided. The API service search system includes a semantic understanding module, a service search and sequence building module, and a match processing module. The semantic understanding module receives a search term and performs a natural language processing analysis on the search term to output a semantic analysis result. The service search and sequence building module provides index data of a plurality of words generated after hyphenation processing is performed on a plurality of service names corresponding to a plurality of API services. The match processing module matches the words in the index data according to the semantic analysis result to output a match result according a match degree.

### CROSS-REFERENCE TO RELATED APPLICATION

This application claims the priority benefit of China patent application serial no. 202110179280.7, filed on Feb. 9, 2021. The entirety of the above-mentioned patent application is hereby incorporated by reference herein and made a part of this specification.

### BACKGROUND

### Technical Field

The disclosure relates to a search technique, and in particular, relates to an application programming interface (API) service search system and an API service search method.

### Description of Related Art

At present, an application programming interface (API) management system may provide an API service of the system itself for other users and third parties to call. Nevertheless, when these provided API services are performed, sometimes it is difficult for a searcher to perform searching owing to problems such as the large number of the API services or unclear API classification. In addition, since the API service names themselves are described in English. As such, when Chinese description is used for searching, additional description data is required to be manually maintained to facilitate searching, and the additional description data is, for example, an additional description field or a data label. In this regard, if a specific API service is not configured or is not updated with the correct additional description data, this specific API service may not be searched. Besides, the Chinese search is also faced with the problem of inconsistency between the description content and the search term, for example, the difference of synonyms, which may lead to unfavorable search accuracy. Therefore, at present, since the abovementioned Chinese search restrictions are still found in the API management system, an accurate and effective API service search function is thus not provided. In view of the above, several solutions are provided in the following embodiments.

### SUMMARY

The disclosure provides an API service search system and an API service search method capable of providing an accurate and convenient API service search function.

According to an embodiment of the disclosure, an API service search system includes a semantic understanding module, a service search and sequence building module, and a match processing module. The semantic understanding module receives a search term and performs a natural language processing (NLP) analysis on the search term to output a semantic analysis result. The service search and sequence building module provides index data of a plurality of words generated after hyphenation processing is performed on a plurality of service names corresponding to a plurality of API services. The match processing module matches the words in the index data according to the semantic analysis result to output a match result according a match degree.

According to an embodiment of the disclosure, an API service search method provided by the disclosure is suitable for an API service search system. The API service search method includes the following steps. A search term is received through a semantic understanding module. A natural language processing analysis is performed on the search term through the semantic understanding module to output a semantic analysis result. Index data of a plurality of words generated after hyphenation processing is performed on a plurality of service names corresponding to a plurality of application programming interface services is provided through a service search and sequence building module. The words in the index data are matched according to the semantic analysis result through a match processing module to output a match result according to a match degree.

To sum up, in the API service search system and the API service search method provided by the disclosure, the index data particularly built according to the service names of the API services may be searched through the semantic analysis result generated by the NLP analysis, and in this way, an accurate and convenient API services search function is provided.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic view of an application programming interface (API) service search system according to an embodiment of the disclosure.

FIG. 2 is a flow chart of an API service search method according to an embodiment of the disclosure.

FIG. 3 is a schematic view of an API service search system according to another embodiment of the disclosure.

FIG. 4 is a flow chart of building of index data according to an embodiment of the disclosure.

FIG. 5 is a flow chart of generation of a semantic analysis result according to an embodiment of the disclosure.

FIG. 6 is a flow chart of generation of a match result according to an embodiment of the disclosure.

### DESCRIPTION OF THE EMBODIMENTS

Descriptions of the disclosure are given with reference to the exemplary embodiments illustrated by the accompanying drawings. Wherever possible, the same reference numbers are used in the drawings and the description to refer to the same or like parts.

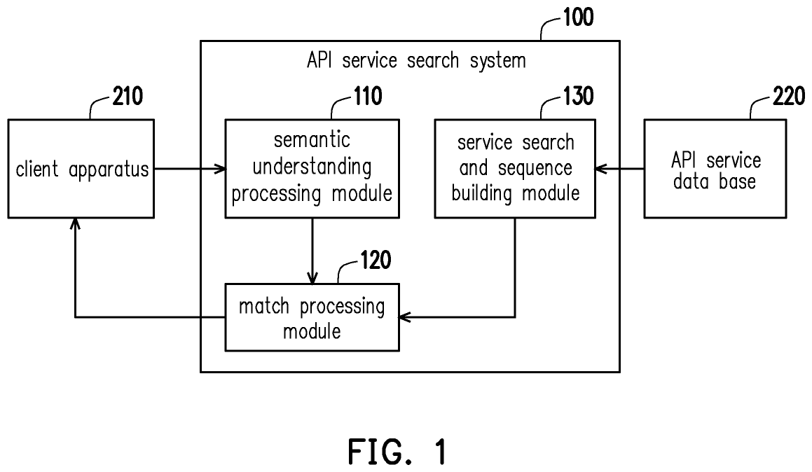

FIG. 1 is a schematic view of an application programming interface (API) service search system according to an embodiment of the disclosure. With reference to FIG. 1, an API service search system 100 includes a semantic understanding processing module 110, a match processing module 120, and a service search and sequence building module 130. The match processing module 120 is coupled to the semantic understanding processing module 110 and the service search and sequence building module 130. The API service search system 100 may be coupled to a client apparatus 210 and an API service database 220. In this embodiment, the API service search system 100 may be built on a cloud server, for example, so as to be implemented as a platform allowing the external client apparatus 210 to be connected and to execute a search service. In this embodiment, the API service database 220 may be built in the same or different server hosts or third-party apparatuses as the API service search system 100, which is not limited by the disclosure.

In some embodiments of the disclosure, the cloud server may include a processor, a memory, and a related functional circuit. Further, the memory may store related application modules or application programs corresponding to the semantic understanding processing module 110, the match processing module 120, and the service search and sequence building module 130 for the processor to access and execute. The processor may implement a related API service search function described in the embodiments of the disclosure through executing the semantic understanding processing module 110, the match processing module 120, and the service search and sequence building module 130. Alternatively, in some other embodiments of the disclosure, the semantic understanding processing module 110, the match processing module 120, and the service search and sequence building module 130 may also be executed or implemented by a separate hardware circuit or processing unit. Alternatively, each of the semantic understanding processing module 110, the match processing module 120, and the service search and sequence building module 130 may also include one or a plurality of sub-application modules or sub-applications.

In this embodiment, the client apparatus 210 is an electronic apparatus that may output a search term (or keyword) according to user operations and may be an apparatus such as a personal computer (PC), a tablet, a smart phone, etc., and a type of the client apparatus 210 is not particularly limited by the disclosure. In this embodiment, the API service database 220 may be, for example, a database provided by an API service provider (third party), and the API service database 220 may store and provide a plurality of API services.

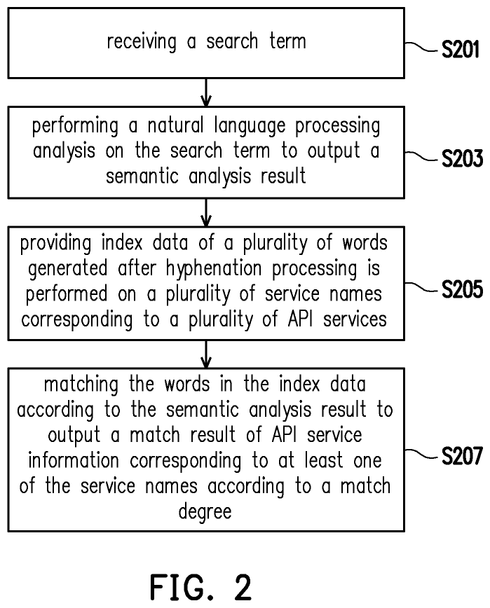

FIG. 2 is a flow chart of an API service search method according to an embodiment of the disclosure. With reference to FIG. 1 and FIG. 2, the API service search system 100 may execute the flow process shown in FIG. 2 to achieve the API service search function. First, a user may input a search term through operating the client apparatus 210. Next, the client apparatus 210 may provide the search term to the API service search system 100. In step S201, the semantic understanding module 110 may receive the search term. In step S203, the semantic understanding module 110 may perform a natural language processing (NLP) analysis on the search term to output a semantic analysis result to the match processing module 120. In this embodiment, the semantic understanding module 110 may cut and transform the search term to analyze corresponding semantic content, and the semantic content may include words of at least one of meaningful “intention” and “entity” (or “noun” and “verb”). The semantic understanding module 110 may provide the semantic analysis result of the semantic content to the match processing module 120.

In step S205, the service search and sequence building module 130 may provide the match processing module 120 with index data of a plurality of words generated after hyphenation processing is performed on a plurality of service names corresponding to a plurality of API services. In this embodiment, the service search and sequence building module 130 may automatically search and disassemble the service names of the API services in advance to build the index data. Herein, the index data may be in a form of list data having a plurality of words, for example. The service search and sequence building module 130 may provide the index data to the match processing module 120 in advance. Alternatively, when the match processing module 120 performs searching, the match processing module 120 reads the index data from the service search and sequence building module 130.

In step S207, the match processing module 120 may match the words in the index data according to the semantic analysis result to output a match result according to a match degree, and the match result is API service information corresponding to at least one of the service names. In this embodiment, the match processing module 120 may match the semantic analysis result with the index data provided by the service search and sequence building module 130 to find a most likely service. Moreover, the match processing module 120 may integrate and add information concerning actual call information to reply to the user. Note that the match degree refers to the degree of matching generated by the semantic understanding module 110 according to matching between one or a plurality of words (or terms) generated by the search term and words in the index data through methods such as fuzzy comparison, text comparison, or vector comparison. The match processing module 120 may extract and compare parts in the one or plural words greater than a predetermined match degree threshold with the words in the index data. In other words, the match processing module 120 may determine a number of the service names that hits the parts of the one or plural words greater than the predetermined match degree threshold in the match result according to the predetermined match degree threshold. Therefore, in this embodiment, an accurate API service search function is provided in the API service search system 100 and the API service search method. In addition, the match result provided by the disclosure is not limited to the API service information. In an embodiment, the match result may include at least one of the API service information corresponding to at least one of the service names and an actual call name.

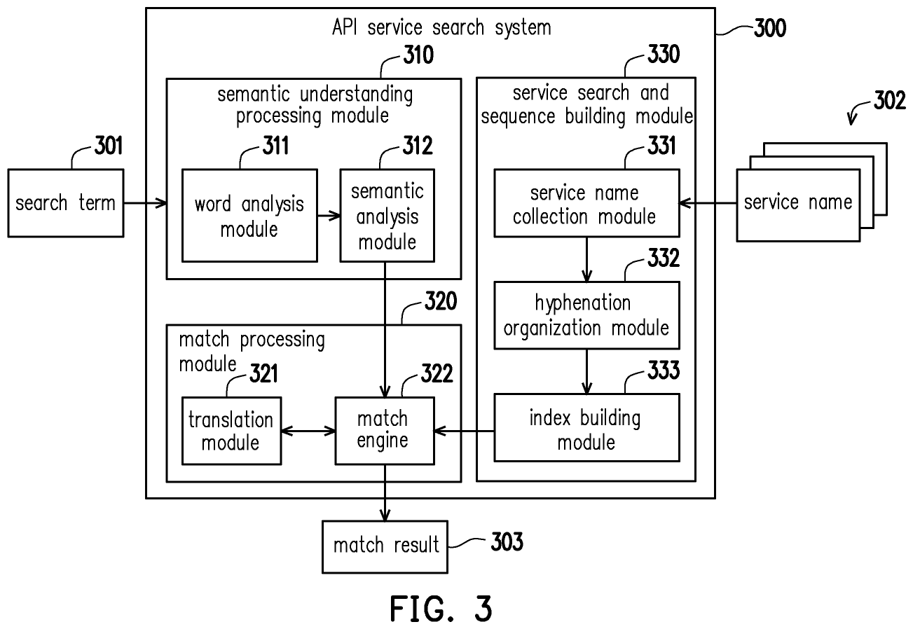

FIG. 3 is a schematic view of an API service search system according to another embodiment of the disclosure. With reference to FIG. 3, FIG. 3 is an example of an API service search system according to some embodiments of the disclosure. In this embodiment, an API service search system 300 includes a semantic understanding processing module 310, a match processing module 320, and a service search and sequence building module 330. The match processing module 320 is coupled to the semantic understanding processing module 310 and the service search and sequence building module 330. The API service search system 300 may be coupled to the client apparatus 210 and the API service database 220 as shown in FIG. 1. In this embodiment, the semantic understanding module 310 may include a word analysis module 311 and a semantic analysis module 312. The word analysis module 311 is coupled to the semantic analysis module 312. The match processing module 320 may include a translation module 321 and a match engine 322. The translation module 321 is coupled to the match engine 322. The service search and sequence building module 330 includes a service name collection module 331, a hyphenation organization module 332, and an index building module 333. The hyphenation organization module 332 is coupled to the service name collection module 331 and the index building module 333. The match engine 322 is coupled to the index building module 333. Note that the match engine 322 and the aforementioned modules may be sub-application modules or sub-applications and are configured to execute specific data calculation functions.

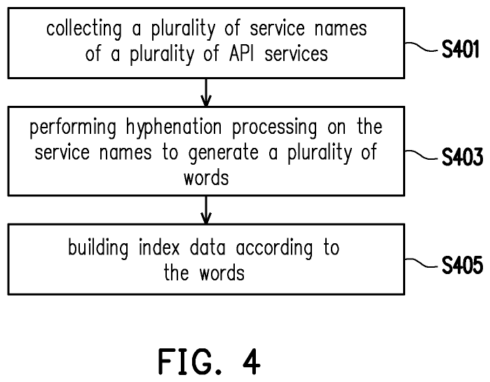

With reference to FIG. 4, FIG. 4 is a flow chart of building of index data according to an embodiment of the disclosure. In this embodiment, the service search and sequence building module 330 may run the flow process shown in FIG. 4 first to build the index data. The service search and sequence building module 330 may be connected to and access the API service database 220 shown in FIG. 1 through a wired or wireless communication form. In step S401, the service name collection module 331 of the service search and sequence building module 330 may collect a plurality of service names 302 of a plurality of API services. In this embodiment, the service names 302 collected by the service name collection module 331 may include “SignOrder”, “ListCustomer”, etc. Nevertheless, in the disclosure, each of the service names collected by the service name collection module 331 may be formed by at least one intention word or at least one entity word and is not limited to the foregoing examples. In step S403, the hyphenation organization module 332 of the service search and sequence building module 330 may performing hyphenation processing on the service names 302 to generate a plurality of words. In this embodiment, the hyphenation organization module 332 may, for example, hyphenate the service names to generate a plurality of intention words including, “sign”, “list”, etc. and a plurality of entity words including “order”, “customer”, etc., for example. In step S405, the index building module 333 of the service search and sequence building module 330 may build index data according to the words. In this embodiment, the index data may be, for example, in a form of list data shown in Table 1 below, for example.

TABLE 1

| Service Name | Intention Word | Entity Word |
|---|---|---|
| SignOrder | sign | order |
| ListCustomer | list | customer |

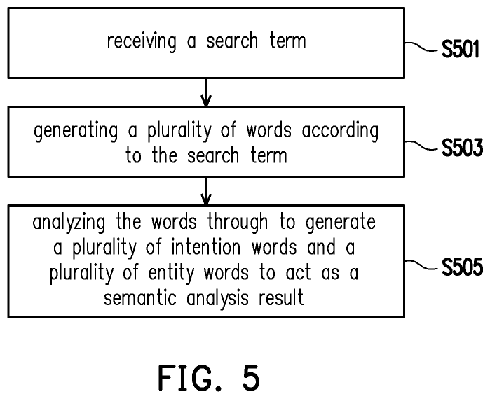

With reference to FIG. 5, FIG. 5 is a flow chart of generation of a semantic analysis result according to an embodiment of the disclosure. In this embodiment, the semantic understanding module 310 may run the flow process shown in FIG. 5 to generate a semantic analysis result. A user may input a search term 301 through the client apparatus 210 shown in FIG. 1. In step S501, the word analysis module 311 of the semantic understanding module 310 may receive the search term 301. In this embodiment, the search term 301 may be, for example, “ [symbol] (Order Examining Service)”. In step S503, the word analysis module 311 of the semantic understanding module 310 may generate a plurality of words according to the search term. In this embodiment, the word analysis module 311 may generate words such as “ [symbol] (Order)”, “ [symbol] (Examining)”, “ [symbol] (Service)”, etc. In step S505, the semantic analysis module 312 of the semantic understanding module 310 may analyze the words to generate a plurality of intention words and a plurality of entity words to act as the semantic analysis result. In this embodiment, the semantic analysis module 312 may generate the intention words (including a match degree parameter) such as “ [symbol] (95%) (Approve (95%))”, “ [symbol] (85%) (Sign (85%))”, “ [symbol] (70%) (Review (70%))”, etc. and the entity words (including a match degree parameter) such as “ [symbol] (95%) (Order (95%))”, “ [symbol] (80%) (Document (80%))”, “ [symbol] (75%) (Receipt (75%))”, etc. according to synonyms and general words of the words. Note that the intention words and the entity words may have different match degree parameters compared to the corresponding words.

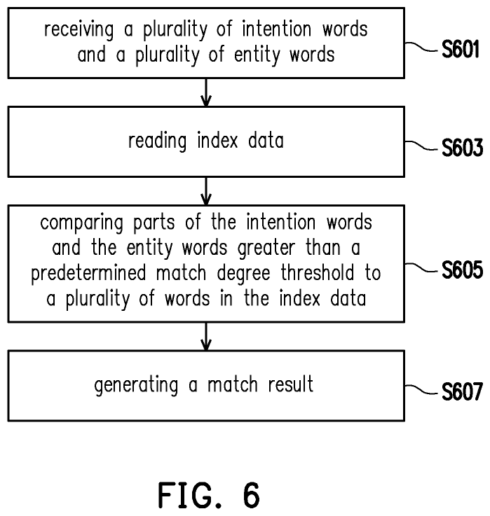

With reference to FIG. 6, FIG. 6 is a flow chart of generation of a match result according to an embodiment of the disclosure. In this embodiment, the match processing module 320 may run the flow process shown in FIG. 6 to generate a match result 303. In step S601, the match engine 322 of the match processing module 320 may receive the intention words and the entity words provided by the semantic analysis module 312. In step S603, the match engine 322 of the match processing module 320 may read the index data generated by the index building module 333. Note that in this embodiment, before step S605 is performed, the translation module 321 may translate the intention words and the entity words from a first language type to a second language type first. Moreover, the service names, the intention words, and the entity words are the second language type. The first language type may be Chinese, and the second language type may be English. Herein, the translation module 321 may, for example, translate the intention words “ [symbol] (95%)”, “ [symbol] (85%)”, and “ [symbol] (70%)” into “Approve (95%)”, “Sign (85%)”, and “Review (70%)” and translate the entity words “ [symbol] (95%)”, “ [symbol] (80%)”, and “ [symbol] (75%)” into “Order (95%)”, “Document (80%)”, and “Receipt (75%)”, so that the match engine 322 may perform matching based on the same language. In other words, in the API service search system 300 provided by the disclosure, the API service of a target may be accurately searched through allowing a user to input the search term in Chinese.

Nevertheless, the first language type and the second language type in the disclosure are not limited to Chinese and English as described above. In addition, in some embodiments of the disclosure, the language type of the search term 301 inputted by the user may be identical to that of the service names, the intention words, and the entity words. In other words, the match processing module 320 is not required to translate the intention words and the entity words through the translation module 321 and may directly perform matching. In addition, in some other embodiments of the disclosure, the translation module 321 may also be disposed in the semantic understanding module 310 and may thus provide the intention words and the entity words to the match processing module 320 after translating the intention words and the entity words.

In step S605, the match engine 322 of the match processing module 320 may compare parts of the intention words and the entity words greater than a predetermined match degree threshold to the words in the index data. For instance, the match engine 322 may be predetermined to only match the intention words (e.g., “Approve (95%)” and “Sign (85%)”) and the entity words (e.g., “Order (95%)” and “Document (80%)”) with a matching degree greater than 80%. Therefore, after arranging the intention words “Approve (95%)” and “Sign (85%)” and the entity words “Order (95%)” and “Document (80%)” into various possible arrangements (e.g., “Approve”, “Sign”, “Order”, “Sign”, “ApproveSign”, “SignApprove”, “ApproveOrder”, “OrderApprove”, “SignOrder”, “OrderSign”, etc.), the match engine 322 may compare the intention words and the entity words with the index data shown in Table 1 and discovers the arrangement that is identical to the service name “SignOrder” after comparison. In step S607, the match engine 322 of the match processing module 320 may generate the match result 303. In this embodiment, the match engine 322 may output the API service information or the actual call name corresponding to the service name “SignOrder” to the client apparatus 210 shown in FIG. 1. The API service search system 300 may therefore be able to provide an accurate and convenient API service search function.

Nevertheless, in some embodiments of the disclosure, when multiple identical service names are discovered by the match engine 322 after comparison, the match engine 322 may output multiple pieces of the API service information or several actual call names according to the match degrees for the user to select and is not limited to provide the match result 303 of the single API service information or the actual call name.

In view of the foregoing, in the API service search system and the API service search method provided by the disclosure, high search accuracy is provided through the plural intention words and the plural entity words generated by the NLP analysis according to the synonyms and general words of the words even with absence of accurate terms provided by a user. In the API service search system and the API service search method provided by the disclosure, match efficiency is effectively increased through building the index data in advance, and a highly efficient search function is therefore achieved. In the API service search system and the API service search method provided by the disclosure, through arrangement of the translation module, a user is allowed to effectively search an API service name described in English through inputting a search term in Chinese, and a convenient Chinese search service is therefor provided.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An application programming interface service search system, comprising:
a semantic understanding module, receiving a search term, performing a natural language processing analysis on the search term to output a semantic analysis result;
a service search and sequence building module, providing index data of a plurality of words generated after hyphenation processing is performed on a plurality of service names corresponding to a plurality of application programming interface services; and
a match processing module, coupled to the semantic understanding module and the service search and sequence building module, matching the words in the index data according to the semantic analysis result to output a match result according a match degree.

2. The application programming interface service search system according to claim 1, wherein the semantic understanding module comprises:
a word analysis module, receiving the search term, generating a plurality of words according to the search term; and
a semantic analysis module, coupled to the word analysis module, analyzing the words to generate a plurality of intention words and a plurality of entity words to act as the semantic analysis result.

3. The application programming interface service search system according to claim 2, wherein the semantic analysis module generates the intention words and the entity words according to at least one of synonyms and general words of the words.

4. The application programming interface service search system according to claim 2, wherein the intention words and the entity words have different match degree parameters compared to the corresponding words.

5. The application programming interface service search system according to claim 2, wherein the match processing module comprises:
a match engine, receiving the intention words and the entity words, reading the index data,
wherein the match engine compares parts of the intention words and the entity words greater than a predetermined match degree threshold to the words in the index data to generate the match result.

6. The application programming interface service search system according to claim 5, wherein the match processing module further comprises:
a translation module, coupled to the match engine, wherein the translation module translates the intention words and the entity words from a first language type to a second language type before the parts of the intention word and the entity words greater than the predetermined match degree threshold are compared to the words in the index data.

7. The application programming interface service search system according to claim 6, wherein the first language type is Chinese, and the second language type is English.

8. The application programming interface service search system according to claim 1, wherein the service search and sequence building module comprises:
a service name collection module, collecting the service names of the application programming interface services;
a hyphenation organization module, coupled to the service name collection module, performing the hyphenation processing on the service names to generate the words; and
an index building module, coupled to the hyphenation organization module, building the index data according to the words.

9. The application programming interface service search system according to claim 1, wherein each of the service names is formed by at least one intention word or at least one entity word.

10. The application programming interface service search system according to claim 1, wherein the match result comprises at least one of application programming interface service information corresponding to at least one of the service names and an actual call name.

11. An application programming interface service search method, suitable for an application programming interface service search system, wherein the application programming interface service search method comprises:
receiving a search term through a semantic understanding module;
performing a natural language processing analysis on the search term through the semantic understanding module to output a semantic analysis result;
providing index data of a plurality of words generated after hyphenation processing is performed on a plurality of service names corresponding to a plurality of application programming interface services through a service search and sequence building module; and
matching the words in the index data according to the semantic analysis result through a match processing module to output a match result according to a match degree.

12. The application programming interface service search method according to claim 11, wherein the step of performing the natural language processing analysis on the search term through the semantic understanding module to output the semantic analysis result further comprises:
receiving the search term through a word analysis module;
generating a plurality of words according to the search term through the word analysis module; and
analyzing the words through a semantic analysis module to generate a plurality of intention words and a plurality of entity words to act as the semantic analysis result.

13. The application programming interface service search method according to claim 12, wherein the step of generating the intention words and the entity words further comprises:
generating the intention words and the entity words according to at least one of synonyms and general words of the words through the semantic analysis module.

14. The application programming interface service search method according to claim 12, wherein the intention words and the entity words have different match degree parameters compared to the corresponding words.

15. The application programming interface service search method according to claim 12, wherein the step of matching the words in the index data according to the semantic analysis result through the match processing module to output the match result according to the match degree comprises:
receiving the intention words and the entity words and reading the index data through a match engine; and
comparing parts of the intention words and the entity words greater than a predetermined match degree threshold to the words in the index data through the match engine to generate the match result.

16. The application programming interface service search method according to claim 15, further comprising:
translating the intention words and the entity words from a first language type to a second language type through a translation module before the parts of the intention word and the entity words greater than the predetermined match degree threshold are compared to the words in the index data.

17. The application programming interface service search method according to claim 16, wherein the first language type is Chinese, and the second language type is English.

18. The application programming interface service search method according to claim 11, wherein the step of providing the index data of the words generated after the hyphenation processing is performed on the service names corresponding to the application programming interface services through the service search and sequence building module further comprises:
collecting the service names of the application programming interface services through a service name collection module;
performing the hyphenation processing on the service names through a hyphenation organization module to generate the words; and
building the index data according to the words through an index building module.

19. The application programming interface service search method according to claim 11, wherein each of the service names is formed by at least one intention word or at least one entity word.

20. The application programming interface service search method according to claim 11, wherein the match result comprises at least one of application programming interface service information corresponding to at least one of the service names and an actual call name.
